(19) United States
(12) Patent Application Publication
(10) Pub. No.: US 2010/0032631 A1
(43) Pub. Date: Feb. 11, 2010

(54) Cable-operated device

(75) Inventors: Yoshikatsu Tsuge, Nagoya-shi (JP); Kazuki Tsuchiya, Nagoya-shi (JP)

Correspondence Address: OLIFF & BERRIDGE, PLC, P.O. BOX 320850, ALEXANDRIA, VA, 22320-4850, US

(73) Assignee: CHUO HATSUJO KABUSHIKI KAISHA, Nagoya-Shi (JP)

(21) Appl. No.: 12/382,611

(22) Filed: Mar. 19, 2009

(30) Foreign Application Priority Data
Aug. 6, 2008 (JP) 2008-203148

(51) Int. Cl. B60T 11/04

(52) U.S. Cl. 254/389

(57) ABSTRACT

A cable-operated device may comprise a moving member, a cable, a supporting member, and a coil spring. One end of the cable may be connected to the moving member. The cable may be arranged so as to advance and retreat with respect to the moving member. The moving member may move as the cable is caused to advance and retreat. The supporting member may support the cable along a pathway on which the cable is arranged. One end of the coil spring may be fixed to the moving member, and the other end thereof may be fixed to the supporting member. The cable may be inserted into the inner hole of the coil spring. At least one of the moving member and the supporting member may comprise a guide surface that makes contact with the coil spring from a lateral direction with respect to the coil spring. At least one portion of the guide surface may comprise an alumite film.

### CROSS-REFERENCE TO RELATED APPLICATION

This application claims priority to Japanese Patent Application No. 2008-203148, filed on Aug. 6, 2008, the contents of which are hereby incorporated by reference into the present application.

### BACKGROUND OF THE INVENTION

1. Field of the Invention

The present invention relates to a cable-operated device that moves a moving member by causing a cable to advance and retreat.

2. Description of the Related Art

In Japanese Utility Model Publication No. 62-13891, a parking brake device including a cable-operated device is disclosed. This parking brake comprises a parking lever and a parking cable. The parking lever is movably arranged with respect to a backing plate. The parking cable is connected to the parking lever. The parking cable is arranged so as to be capable of advancing and retreating with respect to the parking lever, and thus operating force applied to the parking cable will be transmitted to the parking lever.

The parking cable is guided by a coil spring. The coil spring can expand and contract in response to the movement of the parking lever, and thus can guide the parking cable without inhibiting the movement of the parking lever.

A retainer plate that supports the coil spring is arranged on the cable-operated device of the aforementioned prior art. A guide surface that makes contact with the coil spring from the lateral direction thereof is formed on the retainer plate. The guide surface makes contact with the coil spring and thereby guides the coil spring.

### BRIEF SUMMARY OF THE INVENTION

When the coil spring expands and contracts, the coil spring slides with respect to the guide surface. Thus, the coil spring may become worn by the repetitive friction thereof. In a case where the coil spring becomes worn, the coil spring will corrode, and thus the durability of the cable-operated device will decrease.

In consideration of the aforementioned disclosure, the present application provides a technology that can reduce the wear on the coil spring.

The technology disclosed in the present specification is embodied by a cable-operated device. This cable-operated device may comprise a moving member, a cable, a supporting member, and a coil spring. One end of the cable may be connected to the moving member. The cable may be arranged so as to advance and retreat with respect to the moving member. The moving member may move as the cable is caused to advance and retreat. The supporting member may support the cable along a pathway on which the cable is arranged. One end of the coil spring may be fixed to the moving member, and the other end thereof may be fixed to the supporting member. The cable may be inserted into the inner hole of the coil spring. At least one of the moving member and the supporting member may comprise a guide surface that makes contact with the coil spring from a lateral direction with respect to the coil spring. At least one portion of the guide surface may comprise an alumite film.

With this cable-operated device, the guide surface that makes contact with the coil spring comprises an alumite film. As a result, the ability of the coil spring and the guide surface to slide when the coil spring expands and contracts improve. Thus, wear on the coil spring is reduced.

According to the technology disclosed in the present specification, the durability of the coil spring improves because wear on the coil spring is reduced. Thus, the durability of the cable-operated device can be improved.

### BRIEF DESCRIPTION OF THE DRAWINGS

FIG. 1 is a plan view of a brake device according to one embodiment.

FIG. 2 is a cross-sectional view showing a cross-section taken along line II-II of FIG. 1.

FIG. 3 is a flowchart showing the process steps of an alumite processing.

### DETAILED DESCRIPTION OF THE PREFERRED EMBODIMENT

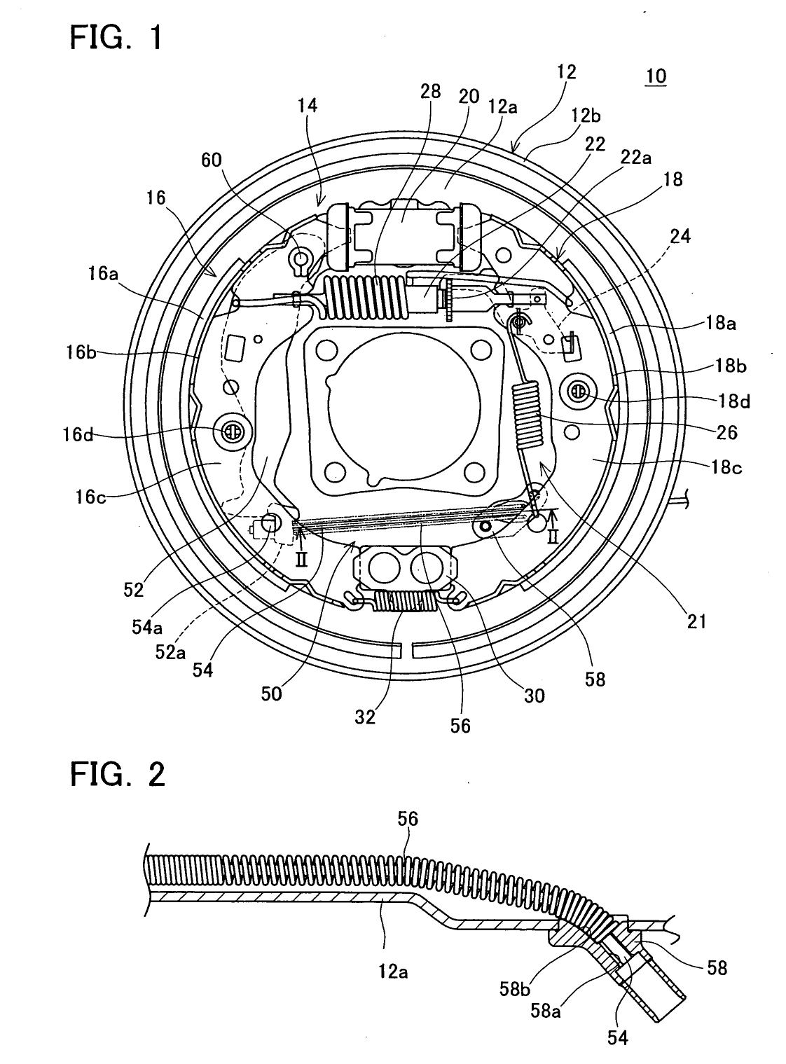

A cable-operated device according to an example embodied by the specification will be described based upon the drawings. In this embodiment, the cable-operated device employed in a parking brake device of an automobile will be described. FIG. 1 is a partial plan view of a drum-type brake device 10 which is arranged on a rear wheel of an automobile. The brake device 10 comprises a back plate 12, a brake shoe assembly 14, a cable-operated device 50, etc.

The back plate 12 includes a disk-shaped base portion 12a, and an outer circumferential portion 12b which is cylindrical in shape along the outer circumferential edge of the base portion 12a. A drum (not shown in the drawings) is arranged along the outer circumferential portion 12b.

The brake shoe assembly 14 comprises brake shoes 16, 18, a cylinder 20, a clearance adjustment device 21, coil springs 28, 32, and an anchor member 30. Each of the brake shoes 16, 18 is supported by the base portion 12a of the back plate 12. The brake shoes 16, 18 are arranged symmetrically. The brake shoe 16 comprises a lining 16a, a rib 16b, and a web 16c. The web 16c has a flat shape. The web 16c is arranged approximately parallel with the back plate 12. The web 16c is elastically supported on the base portion 12a by a shoe supporting member 16d. An outer lateral end of the web 16c (the end on the left in FIG. 1) is formed in an arc shape. The rib 16b is an approximately flat plate that is fixed approximately perpendicular to the outer lateral end of the web 16c. The lining 16a is adhered to the outer lateral surface of the rib 16b.

Like the brake shoe 16, the brake shoe 18 comprises a lining 18a, a rib 18b, and a web 18c. The web 18c is elastically supported on the base portion 12a by a shoe supporting member 18d. The brake shoe 18 is configured in approximately the same construction as the brake shoe 16, and thus a description of the portions that overlap with the description of the brake shoe 16 is omitted. The brake shoe 18 is arranged symmetrically with the brake shoe 16.

Each upper end of webs 16c, 18c is engaged with a piston (not shown in the drawings) inside the cylinder 20. The cylinder 20 is fixed to the base portion 12a. The coil spring 28 is arranged below the cylinder 20. The left end of the coil spring 28 is engaged with the web 16c, and the right end thereof is engaged with the web 18c. The coil spring 28 urges the brake shoes 16, 18 in a direction that reduces the gap therebetween. In addition, the coil spring 32 is arranged on the lower end of the web 16c. The left end of the coil spring 32 is engaged with the lower end of the web 16c, and the right end thereof is engaged with the lower end of the web 18c. The coil spring 32 urges the brake shoes 16, 18 in a direction that reduces the gap therebetween. The anchor member 30 is arranged above the coil spring 32. The anchor 30 supports the ends of webs 16c, 18c.

The clearance adjustment device 21 comprises a strut 22, a lever 24, and a coil spring 26. The strut 22 is inserted into the inner hole of the coil spring 28. The right end of the strut 22 is engaged with the web 18c. The left end of the strut 22 is engaged with a brake lever 52 described below. The strut 22 includes a dial 22a that adjusts the length of the strut 22 in the longitudinal direction (the horizontal direction of FIG. 1). The dial 22a is arranged to be contactable with one end of the lever 24. The lever 24 is rotationally supported on the right end of the strut 22. The lever 24 is urged in a counterclockwise direction by the coil spring 26. One end of the coil spring 26 is engaged with the web 18c. With the clearance adjustment device 21, the lever 24 may be rotated by the coil spring 26, and the dial 22a may be rotated to adjust the length of the strut 22 as needed. Therefore, the clearance of the brake shoes 16, 18 will be adjusted.

The cable-operated device 50 comprises a cable 54, a brake lever 52, a coil spring 56, and a supporting member 58. The brake lever 52 is arranged between the web 16c and the base portion 12a. The brake lever 52 includes flat plate which extends in the vertical direction of the brake device 10. The upper end portion of the brake lever 52 is rotatably supported by a pin 60 that passes through and is fixed to the upper portion of the web 16c. The left end of the strut 22 is engaged with the brake lever 52 below the pin 60. A cable support portion 52a is formed on the lower end of the brake lever 52. Though not shown in the drawings, the cable support portion 52a is U-shaped in cross-section with a groove along the internal curve thereof, through which the cable 54 passes. The cable support portion 52a supports one end of the cable 54. The surface of the cable 54 is coated with a resin along the entire length thereof. The cable 54 is inserted into the inner hole of the coil spring 56. A cable end 54a having a cylindrical shape which is larger in diameter than the coil diameter on the end portions of the coil spring 56 is fixed to one end of the cable 54. The cable end 54a may, for example, be a polygon shaped column such as a square column, a hexagonal column, or the like. The cable end 54a makes contact with the left end of the cable support portion 52a. The cable 54 is thereby fixed to the brake lever 52. A parking brake lever (not shown in the drawings) is connected to the other end of the cable 54.

The right end of the coil spring 56 is supported by the supporting member 58. The cable 54 extends through a through opening 58a of the supporting member 58 and arranged inside the brake device 10. FIG. 2 is a cross-sectional view showing a cross-section taken along line II-II of FIG. 1. As shown in FIG. 2, by passing the cable 54 through the through opening 58a, the cable 54 is supported by the supporting member 58. The supporting member 58 is manufactured from an aluminum alloy. The supporting member 58 is manufactured from aluminum die-casting. A guide surface 58b is formed on the supporting member 58. The entire surface of the supporting member 58b is treated with an alumite processing. The entire surface of the supporting member 58b comprises an alumite film (anodic coating film).

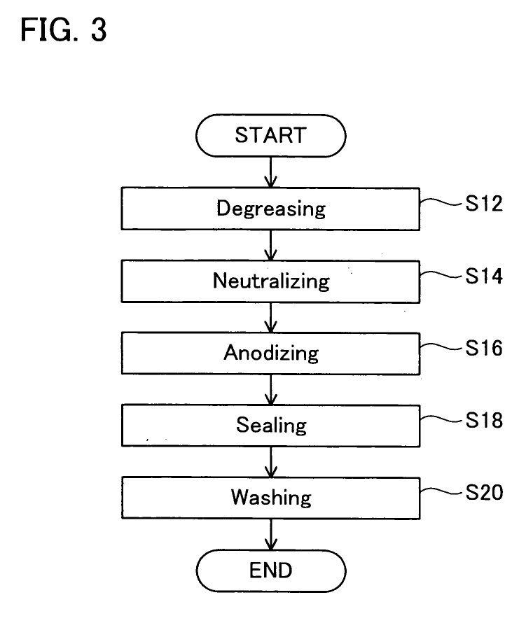

FIG. 3 is a flowchart showing the process steps of an alumite processing. In the alumite processing, the surface of the supporting member 58 manufactured from aluminum die-casting is degreased by a degreasing agent (S12). Next, the degreasing agent that has adhered to the surface of the supporting member 58 is neutralized (S14). The supporting member 58 then is anodized (S16). In the anodizing step, sulfuric acid at a temperature of approximately 20° C. may be employed as an electrolyte. The anodization step may be performed for approximately 30 minutes. Next, a sealing step (S18) is performed. Then, the supporting member 58 is washed in hot water (S20), and the alumite processing is completed. The film thickness of the aluminum oxide formed by the alumite processing is approximately 7 μm. In the aforementioned alumite processing, a color application step may be added between the anodization step (S16) and the sealing step (S18). In the color application step, color (for example, black) is applied to the surface of the supporting member 58. For example, various color application methods can be employed in the color application step, such as employing a colorant to color the surface of the supporting member 58, or performing a secondary electrolysis while the supporting member 58 is in the electrolytic bath in order to cause a metal to be precipitated and adsorbed onto the innermost portion of the alumite porous layer in order to apply color thereto.

The coil spring 56 is brought into contact with the guide surface 58b of the supporting member 58 and curves. Both end portions of the coil spring 56 are so-called close wound, i.e., wound with a tight pitch so that adjacent wires are in contact with each other in their natural shape (the shape when there is no load thereon). In contrast, the central portion of the coil spring 56 is wound with a loose pitch so that adjacent wires are separated from each other. Although not particularly limited thereto, the pitch in the central portion of the coil spring 56 in the present embodiment is 2.0 mm. The entire surface of the coil spring 56 is zinc-iron plated.

Next, the operation of the cable-operated device 50 will be described. In a case where the driver of the automobile operates the parking brake, and the cable 54 is pulled to the right side as shown in FIG. 1, the brake lever 52 rotates in the counterclockwise direction using the pin 60 as a fulcrum. Therefore, the brake shoe 18 is moved in the direction away from the brake shoe 16 via the strut 22 by using the anchor member 30 as a fulcrum. In accordance with this, the brake shoe 16 also is moved in the direction away from the brake shoe 18 by using the anchor member 30 as a fulcrum. As a result, the brake shoes 16, 18 come into contact with the inner circumferential surface of the drum. The parking brake thus becomes operated. In this case, force is applied in the compression direction on the coil spring 56 by the brake lever 52 and the supporting member 58. In a case where the driver of the automobile operates the parking brake lever and the pulling force of the cable 54 is relaxed, the brake lever 52 rotates in the clockwise direction around the pin 60 acting as the fulcrum due to the urging force of the coil spring 56. Hence, the brake shoes 16, 18 are moved toward each other, and the parking brake is released.

The coil spring 56 is expanded and contracted in response to the rotation of the brake lever 52 by the cable 54. In this case, the coil spring 56 slides along the guide surface 58b of the supporting member 58. The surface of the supporting member 58 of the cable-operated device 50 is treated with the alumite processing. The surface of the coil spring 56 is zinc-iron plated. As a result, wear on the coil spring 56 is reduced. Therefore, the durability of the coil spring 56 is improved. According to an experiment performed by the present inventors, in a case where the cable 54 was repeatedly caused to advance and retreat 100,000 times, the amount of wear on the coil spring 56 which was slid along the guide surface 58b was approximately 120 μm, compared to an amount of wear of approximately 232 μm on the coil spring 56 with which a guide surface that was not treated with the alumite processing was employed. That is, the amount of wear was reduced by half.

In addition, even where the type of metal plating on the coil spring 56 was experimentally changed to zinc plating or nickel plating, there was less wear on the coil spring 56 of the cable-operated device that employed the guide surface 58b treated with the alumite processing than the cable-operated device that employed a guide surface that was not alumite processed.

In addition, the cable-operated device 50 that employed the coil spring 56 treated with metal plating (e.g., zinc plating, nickel plating, zinc-iron plating, etc.) had less wear on the coil spring than in the cable-operated device that employed a coil spring that was not metal plated. In particular, a coil spring 56 treated with zinc-iron plating had much less wear than with other types of metal plating. In addition, the results of an experiment in which coil springs were treated with different types of metal plating were employed and salt water was sprayed on the coil springs after having operated the parking brake lever 100,000 times showed that, a coil spring 56 treated with the zinc-iron plating lasted significantly longer before corrosion began than with the other types of metal plating.

Specific examples of the present application were described in detail above; however, these are simply illustrations, and do not limit the scope of the claims. The technology described in the scope of the claims includes various modifications and variations, and the specific examples illustrated above can be changed accordingly.

For example, in the aforementioned example, the entire surface of the supporting member 58 is treated with an alumite processing. However, the alumite processing may be performed on at least one portion of the guide surface 58b.

In addition, in the aforementioned example, the entire surface of the coil spring 56 is, for example, treated with zinc-iron plating. However, the zinc-iron plating may be performed on only the portion of the coil spring 56 that slides on the guide surface 58b.

In addition, for example, a plurality of supporting members 58 may be provided. In this case, the guide surface 58b may be formed on any of the supporting members 58.

In addition, for example, the coil spring 56 need not be tightly wound.

In addition, the technological components described in the present specification or the drawings exhibit technological utility individually or in various combinations, and are not limited to the combinations disclosed in the claims at the time of application. In addition, the technology illustrated in the present specification or the drawings simultaneously achieve a plurality of objects, and achieving one object from amongst these has technological utility in and of itself.

Some of the technology described in the aforementioned example will be disclosed below.

The cable-operated device may be optimally employed in a parking brake device of an automobile. However, a cable-operated device that moves a moving member connected to a cable by causing the cable to advance and retreat may be used in devices other than the parking brake device. Utilization of the present cable-operated device may result in reduction of the amount of wear on the coil spring, and the durability of the cable-operated device thereof may be improved.

One or a plurality of supporting members may be provided. In addition, a guide surface may be formed on each of the supporting members. In this case, at least one guide surface may be treated with the alumite processing, or all guide surfaces may be treated with the alumite processing. Therefore, the amount of wear on the portions of the coil spring that slide on the guide surface treated with the alumite processing can be reduced.

The alumite processing may be performed on at least one portion of the guide surface of the supporting member, may be performed on the entire surface of the supporting member, or may be performed on at least one portion of the guide surface and at least one portion of the surface of the supporting member other than the guide surface. Regardless of which, the amount of wear on the portions of the coil spring that slide on the guide surface treated with the alumite processing can be reduced.

The coil spring may be treated with metal plating on the areas which contact with at least the guide surface, or may be treated with metal plating on a portion or all areas that do not contact with the guide surface. Regardless of which, the amount of wear on the portions of the coil spring that slide on the guide surface treated with the alumite processing can be reduced.

The cable-operated device may also comprise a metal plating film on the area of the coil spring that contacts with at least the guide surface.

According to this construction, the ability of the coil spring and the guide surface to slide when the coils spring expands and contracts further improve. Therefore wear on the coil spring will be further effectively reduced.

The metal plating film formed on the coil spring may be a zinc-iron plating film.

As a result of experiments by the present inventors, it was learned that amongst all metal plating, zinc-iron plating is the most effective in reducing wear on the coil spring.

What is claimed is:

1. A cable-operated device comprising:
a moving member;
a cable having one end connected to the moving member and arranged such that the cable is capable of advancing and retreating with respect to the moving member, wherein the moving member is moved while the cable is caused to advance and retreat;
a supporting member that supports the cable along a pathway on which the cable is arranged; and
a coil spring having one end fixed to the moving member and another end fixed to the supporting member, wherein the cable is inserted in an internal hole of the coil spring,
wherein at least one of the moving member and the supporting member comprises a guide surface making contact with the coil spring from a lateral direction with respect to the coil spring, and
at least a part of the guide surface comprises an alumite film.

2. The cable-operated device as in claim 1, wherein
the coil spring comprises a metal plating film within at least an area that makes contact with the guide surface.

3. The cable-operated device as in claim 2, wherein
the metal plating film is zinc-iron plating film.
